(19) United States
(12) Patent Application Publication
(10) Pub. No.: US 2020/0119676 A1
(43) Pub. Date: Apr. 16, 2020

(54) SYSTEM AND METHOD FOR CONTROLLING AN INDUCTION MOTOR

(71) Applicant: GM Global Technology Operations LLC, Detroit, MI (US)

(72) Inventors: Siddharth Ballal, Shelby Township, MI (US); Anno Yoo, Rochester, MI (US)

(73) Assignee: GM Global Technology Operations LLC, Detroit, MI (US)

(21) Appl. No.: 16/160,147

(22) Filed: Oct. 15, 2018

(51) Int. Cl. H02P 21/22; H02P 21/14; H02P 21/20; H02P 21/00

(52) U.S. Cl. CPC H02P 21/22; H02P 21/0089; H02P 21/20; H02P 21/141

(57) ABSTRACT

A method regulates operation of an induction motor by generating d-axis and q-axis current command references, and generating a current compensation value using a modulation index and an actual/feedback modulation index. An angle (θ) is derived between constant torque direction and decreasing voltage ellipse unit vectors, with separate d-axis and q-axis components of the current compensation value also derived. A direction of compensation is determined using angle (θ). The direction is that of the constant torque unit vector when cos θ exceeds a calibrated threshold, and in the direction of the decreasing voltage ellipse unit vector otherwise. The d-axis and q-axis components are added to the d-axis and q-axis current command references in the determined direction to derive final d-axis and q-axis current commands, which are used to control motor torque. An electric system and motor vehicle include the controller.

### INTRODUCTION

An induction motor includes a stator and a bearing-mounted rotor, with the stator and rotor separated from each other by a small air gap. Output torque from an induction motor is controlled by modifying the strength of a rotating magnetic field, which in turn adjusts the amount of electrical current flowing in the stator's windings. It may be desirable to maintain power consumption of the motor during periods of increasing motor speed, e.g., by limiting an increase in supply voltage or current to the stator windings. However, power is the product of the motor's rotational speed and torque, and therefore efforts toward maintaining power at a steady-state level during periods of increasing motor speed require a corresponding reduction in motor torque. Flux-weakening is a control tactic employed in designated flux-weakening regions of operation in order to reduce torque. In this way, overall operating efficiency may be improved at higher motor speeds.

### SUMMARY

A strategy is disclosed herein for controlling an induction motor having a stator and a rotor. The disclosed control strategy uses programmed control logic in the form of a flux-weakening regulator to generate electrical current references that are used to improve torque accuracy in flux-weakening regions of operation, with increased voltage utilization occurring in a designated maximum torque per voltage (MTPV) region of the induction motor.

In particular, the strategy uses an angle between a pair of unit vectors, i.e., a constant torque direction vector and a decreasing voltage ellipse unit vector, to determine precisely when to enter the above-noted MTPV region. In a flux-weakening region below the MTPV region, the constant torque unit vector is used to adjust a direct-axis (d-axis) current command and a quadrature-axis (q-axis) current command to the stator. A magnitude of compensation of the d-axis and q-axis current commands is separately derived using additional control logic.

With an angle (θ) defined between the constant torque direction and decreasing voltage ellipse unit vectors, the constant torque unit vector is used to determine the direction of current command compensation when cos θ is greater than or equal to a calibrated threshold. The decreasing voltage ellipse unit vector is used in lieu of the constant torque unit vector when cos θ is less than the calibrated threshold. Cos θ may be calculated online to properly account for variations in motor temperature and DC-link voltage ultimately driving the induction motor.

An example method for regulating operation of the induction motor includes generating d-axis and q-axis current command references for the stator using a controller, and generating a current compensation value using a commanded modulation index and an actual/feedback modulation index of the induction motor. The method also includes deriving an angle (θ) between a constant torque direction unit vector and a decreasing voltage ellipse unit vector of the induction motor, as well as deriving separate d-axis and q-axis components of the current compensation value.

As part of the method, the controller also determines a direction of the current command compensation using the angle (θ). The direction of the current command compensation is in the direction of the constant torque unit vector when cos θ is greater than or equal to a calibrated threshold, and in the direction of the decreasing voltage ellipse unit vector when cos θ is less than the calibrated threshold. The method includes adding the d-axis and q-axis components to the d-axis and q-axis current command references at the determined direction to derive final d-axis and q-axis current commands. Torque operation of the induction motor is thereafter controlled using the final d-axis and q-axis current commands.

An electric system includes the induction motor and controller noted above.

A motor vehicle is also disclosed herein that includes a transmission having an input member and an output member, a set of road wheels connected to the output member, the induction motor, and the controller. The rotor is connected to the input member of the transmission in an example embodiment.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of an example electrical system having a polyphase induction motor coupled to a load and controlled in a flux-weakening region according to the present control strategy.

FIG. 2 is a schematic logic flow diagram of the controller shown in FIG. 1.

FIG. 3 is a plot of constant torque terms, voltage ellipses, and maximum torque per ampere (MTPA) lines, with q-axis current commands depicted on the vertical axis and d-axis current commands depicted on the horizontal axis, and with FIG. 3 illustrating constant torque direction vectors and decreasing voltage ellipse unit vectors used as part of the present control strategy.

FIG. 4 is a flow chart describing an example method for implementing a control strategy of FIG. 2.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and/or combinations falling within the scope of the disclosure as encompassed by the appended claims.

### DETAILED DESCRIPTION

This disclosure is susceptible of embodiment in many different forms. Representative embodiments of the disclosure are shown in the drawings and will herein be described in detail with the understanding that these examples are provided as a representation of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

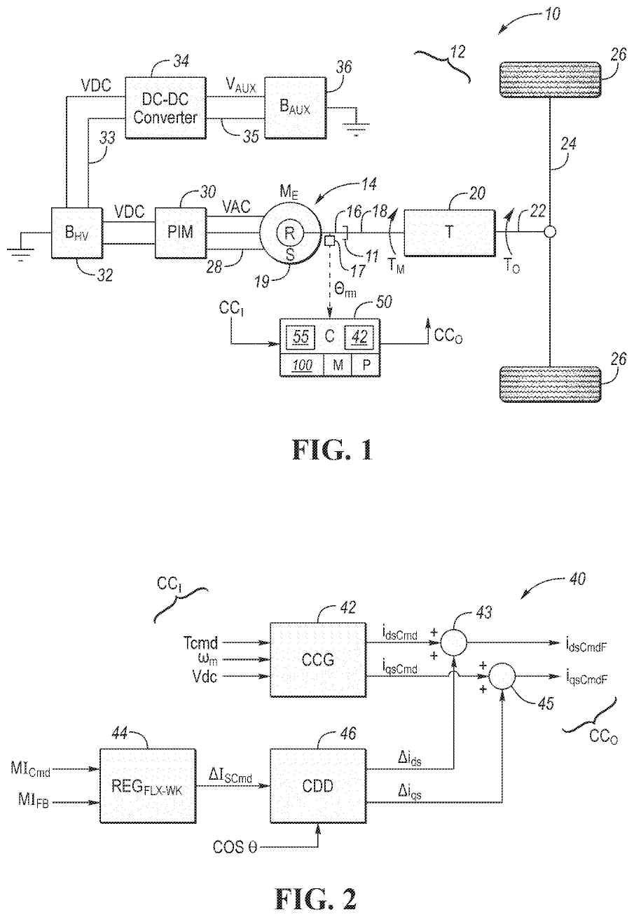

Referring to the drawings, wherein like reference numbers correspond to like or similar components throughout the several figures, an example vehicle 10 is shown in FIG. 1 having an electrical system 12. The electrical system 12 includes an induction motor (M_{E}) 14 whose operation is regulated in real-time via a controller (C) 50. The controller 50 receives control input signals (arrow CC_{I}) and, in response, generates control output signals (arrow CC_{O}), with the output signals (arrow CC_{O}) ultimately increasing, decreasing, or maintaining output torque (arrow T_{M}) of the induction motor 14.

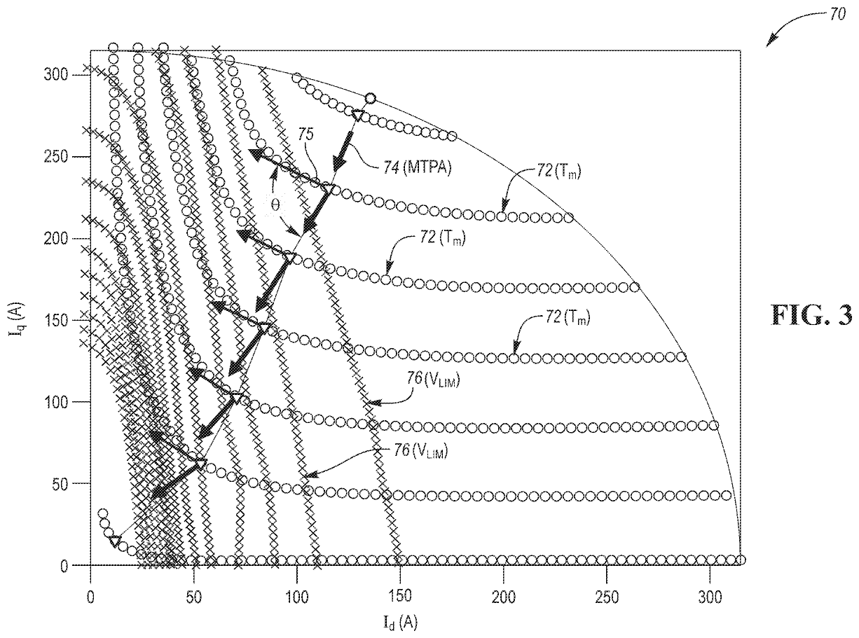

As part of this control effort, the controller 50 automatically executes a control strategy embodied as an example method 100. In executing the method 100, the controller 50 uses a flux-weakening regulator 55 to generate direct-axis (d-axis) and quadrature (q-axis) current references in manner that improves torque accuracy in a designated flux-weakening region of operation of the induction motor 14. In general, the controller 50 considers, as part of the input signals (arrow CC_{I}), an angle between a constant torque unit vector and a decreasing voltage ellipse unit vector to determine a starting point for entering a designated maximum torque per voltage (MTPV) region of the induction motor 14. The flux-weakening regulator 55, the function of which maximizes torque generation by increasing voltage utilization in the MTPV region, may be implemented as part of a programmed set of control logic 40 as shown in FIG. 2 and described with further reference to FIG. 3.

The example electric system 12 of FIG. 1 is described herein as part of the vehicle 10 solely for the purpose of illustration, and thus without limiting the electric system 12 to vehicular use in general or automotive applications specifically. That is, induction machines such as the induction motor 14 are widely used in manufacturing environments, power plants, and in consumer products, as well as in non-automotive applications such as rail vehicles, aircraft, and marine vessels. The induction motor 14 may be embodied as a polyphase/alternating current (AC) induction machine having a stator (S) 19 and a rotor 16, the speed of which may be measured by a rotary position sensor 17 and communicated to the controller 50 as a measured rotor speed (θᵣₘ).

In the illustrated application within the vehicle 10, the rotor 16 may be selectively coupled to an input member 18 of a transmission (T) 20 via an input clutch 11, such as a friction clutch or a hydrodynamic torque converter. The transmission 20 may include one or more internal clutches and gear sets (not shown) that ultimately transfer the motor output torque (T_{M}) from the input member 18 to an output member 22 to produce transmission output torque (T_{O}). Although not shown in FIG. 1, the vehicle 10 may include an internal combustion engine and/or additional electric machines which, depending on the operating mode, may combine with the motor output torque (T_{M}) to provide the output torque (T_{O}) at a desired level. The output torque (arrow T_{O}) is then transmitted to one or more drive axles 24, which in turn are coupled to a load, in this instance road wheels 26.

As part of the electric system 12 of FIG. 1, phase windings of the induction machine 14 may be energized via a polyphase voltage (VAC) present on an AC voltage bus 28. The polyphase voltage (VAC) may be produced using a power inverter module (PIM) 30 via internal semiconductor switching and signal filtering, as will be appreciated by those of ordinary skill in the art. A direct current (VDC) supply voltage to the PIM 30, also referred to as a DC-link voltage, may be provided by a high-voltage battery pack (B_{HV}) 32 over a DC voltage bus 33, with the DC voltage bus 33 possibly connected to a DC-DC voltage converter 34. The output of the DC-DC voltage converter 34 may be provided over an auxiliary voltage bus 35 at a reduced/auxiliary voltage (V_{AUX}), e.g., 12-15V suitable for storage in an auxiliary battery (B_{AUX}) 36.

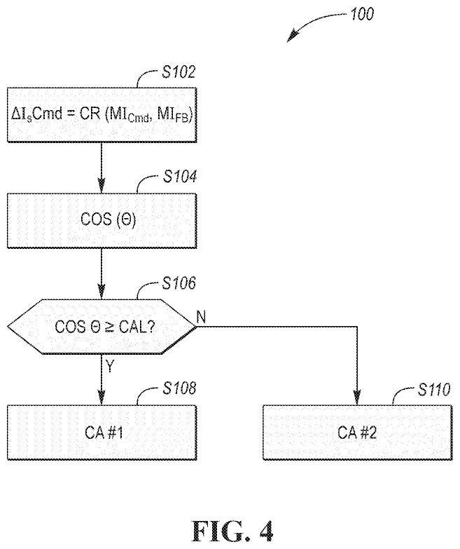

Referring to FIG. 2, an example set of control logic 40 is depicted according to an example embodiment, with the control logic 40 usable in implementing the method 100 shown in FIG. 4 and explained below. The input signals indicated as arrow CC_{I} in FIG. 1 may be fed into a Current Command Generator (CCG) logic block 42, with the input signals (CC_{I}) including a commanded torque (T_{Cmd}), motor speed (ωₘ), i.e., rotational speed of the rotor 16 as measured by the position sensor 17 of FIG. 1 and/or calculated/estimated using such measurements, and the DC voltage command (V_{dc}) to the PIM 30, i.e., the DC link voltage noted above. The CCG logic block 42 outputs the d-axis current command (i_{dsCmd}) and the q-axis current command (i_{dsCmd}) for the stator 19, as indicated by the subscript “s”, as two control signals. The d-axis and q-axis current commands (i_{dsCmd} and i_{qsCmd}) respectively fed to respective first and second summation nodes 43 and 45.

As will be appreciated, d-q axis transformation is a commonly used mathematical transformation technique for simplifying the analysis of polyphase electrical circuits, e.g., a three-phase AC circuit of the type contemplated by the present disclosure. The d-axis is the axis on which magnetic flux is generated, while the q-axis is the axis on which torque is ultimately generated. By convention, the q-axis leads the d-axis by 90°. Thus, d-axis and q-axis current commands from a controller to the stator, and resultant d-axis and q-axis currents in the rotor, are regulated to produce a desired effect on the induction motor's torque operation. Also as will be understood in the art, a dynamical model of an electric machine such as the example induction motor 14 shown in FIG. 1 includes three reference frames: a stationary reference frame in which the d-axis and q-axis do not rotate, a rotor reference frame in which the d-axis and q-axis rotate at rotor speed, and a synchronous reference frame in which the d-axis and q-axis rotate at the synchronous speed of the induction motor.

A flux-weakening control loop 55 is programmed to calculate compensation terms for the outputs of the CCG logic block 42 (i_{dsCmd} and i_{qsCmd} ). Input signals (CC_{I}) to the flux-weakening control loop 55 in this embodiment include a Modulation Index command (MI_{Cmd}) and a Modulation Index feedback term (MI_{FB}), with the former being a commanded modulation index and the latter being the actual modulation index. As used herein and in the art, “modulation index”, particularly with respect to PWM-based inverters such as the PIM 30 of FIG. 1, refers to a level of signal modulation of a particular variable, e.g., the amplitude or frequency of an input waveform depending on the modulation scheme, with the modulation index typically ranging from 0 to 1. A Flux Weakening Regulator (REG_{FLX-WK}) logic block 44 receives the Modulation Index command (MI_{Cmd}) and Modulation Index feedback term (MI_{FB}), and in response, calculates a required magnitude of current compensation (ΔI_{SCmd}).

Still referring to FIG. 2, the required magnitude of current compensation term (ΔI_{sCmd}) is fed into a Compensation Direction Determination (CDD) logic block 46 along with the above-described cosine value cos (θ), once again with the angle θ being the particular angle defined between the constant torque unit vector and the decreasing voltage ellipse unit vector, as will be explained in further detail below with reference to FIGS. 3 and 4. The CDD logic block 46 processes the current compensation term (ΔI_{sCmd}) and the cos(θ) value to derive the required constituent d-axis and q-axis components (Δi_{ds} and Δi_{qs}) of the current compensation term (ΔI_{sCmd}). These two values are then added at respective summation nodes 43 and 45 to the d-axis and q-axis current commands (i_{dsCmd} and i_{qsCmd}) output by the CCG logic block 42. The sums are the final d-axis and i-axis current commands (i_{dsCmdF} and i_{qsCmdF}) used by the controller 50 of FIG. 1 to control the overall torque operation of the induction motor 14.

FIG. 3 depicts a set of performance curves 70 for the induction motor 14 of FIG. 1, with the q-axis and d-axis currents i_{d} and i_{q} in amps (A) shown on the vertical and horizontal axis, respectively. Traces 72 represent output torque curves for the induction motor 14 and thus are labeled (T_{M}) to correspond to the motor torque shown in FIG. 1. A control goal is to remain on one of the traces 72 to maximize the motor output torque (T_{M}), with traces 72 showing corresponding maximum motor torques for various q-axis and d-axis current commands. Traces 76 represent voltage limits (V_{LIM}) of the induction motor 14, and thus act as another set of performance curves.

The trajectories of the traces 72 and 76 are specific to the induction motor 14, and thus may be calibrated ahead of time and available to the controller 50, e.g., extracted from lookup tables. Intersection points of the traces 72 and 76 correspond to the lowest possible level of current for a given torque level. Traces 76 define voltage ellipses for a given motor speed, with such ellipses shrinking as speed increases. Thus, for a given trace 72, operation will occur to the left of an intersecting traces 76, i.e., inside of the ellipse.

The performance curves 70 additionally include unit vectors 74 and 75 representing the constant torque direction and the deceasing voltage direction, respectively. The constant torque direction of unit vector 75 may be determined as follows:

$$‖ ( - \frac{\partial {T}_{e}}{\partial {i}_{qs}^{e}} , \frac{\partial {T}_{e}}{\partial {i}_{ds}^{e}} ) ‖ = \frac{( - {i}_{ds}^{e} , {i}_{qs}^{e} )}{\sqrt{{( - {i}_{ds}^{e} )}^{2} + {{i}_{qs}^{e}}^{2}}} = ( {T}_{1} , {T}_{2} )$$

with ∂ being a time derivative, Te representing the electromagnetic torque in the synchronous reference frame (e), (T₁, T₂) being the unit vector in the constant torque direction as noted above and depicted in FIG. 3 as arrows 75, and i_{ds}^{e} and i_{qs}^{e} representing the d-axis and q-axis stator currents, also in the synchronous reference frame (e). A voltage cost function (J) may be defined as:

J=½(v^{e}_{ds}²+v^{e}_{qs}²)

with v_{ds}^{e} and v_{qs}^{e} respectively representing the d-axis and q-axis stator voltages in the synchronous reference frame (e).

The direction of decreasing voltage in control of the induction motor 14 of FIG. 1 is defined as (V₁, V₂):

$$‖ ( - \frac{\partial J}{\partial {i}_{ds}^{e}} , - \frac{\partial J}{\partial {i}_{qs}^{e}} ) ‖ = \frac{( - {ω}_{e} {L}_{s} {v}_{qs}^{e} , {ω}_{e} σ {L}_{s} {v}_{ds}^{e} )}{\sqrt{( {( - {ω}_{e} {L}_{s} {v}_{qs}^{e} )}^{2} + {( {ω}_{e} σ {L}_{s} {v}_{ds}^{e} )}^{2} )}} = ( {V}_{1} , {V}_{2} )$$

with ωₑ being the electrical frequency of the supply voltage from the PIM 30 of FIG. 1, Ls being the inductance of the stator, σLs being the transient inductance of the stator, and (V₁, V₂) being the decreasing voltage ellipse unit vector as noted above and depicted in FIG. 3 as arrows 74. Taking the inner product of the unit vectors (T₁, T₂) and (V₁, V₂), cos θ is derived as follows:

(T₁·V₁+T₂·V₂)=cos θ

Referring to FIG. 4, the method 100 according to an example embodiment commences with step S102, with the controller 50 calculating the current command compensation (ΔI_{SCmd}) using the Flux-Weakening Regulator logic block 44 of FIG. 2. The controller 50 may implement block 44 as a proportional-integral control loop, and thus calculate the value (ΔI_{SCmd}) as an error or difference between the commanded modulation index (MI_{Cmd}) and the actual or feedback value (MI_{FB}). The method 100 then proceeds to step S104.

At step S104, the controller 50 calculates the value of (cos θ) as set forth above before proceeding to step S106.

Step S106 entails comparing the value of (cos θ) from step S104 to a calibrated threshold. The method 100 proceeds to step S108 when the calculated value of (cos θ) equals or exceeds the calibrated threshold, and to step S110 in the alternative when the value of (cos θ) is less than the threshold.

Steps S108 and S110 are executed depending on the result of the above-noted threshold comparison, i.e.,:
IF cos θ>=threshold:

Δi_{ds}=(ΔI_{SCmd})(T₁)

Δi_{qs}=(ΔI_{SCmd})(T₂)
ELSE

Δi_{ds}=(ΔI_{SCmd})(V₁)

Δi_{qs}=(ΔI_{SCmd})(V₂).

Step S108 thus entails executing a first control action (CA #1) with respect to the induction motor 14. The first control action may include using the constant torque direction unit vector (T₁, T₂) to calculate the direction of (Δi_{ds}) and (Δi_{qs}), with the controller 50 applying the direction of such terms to the commanded values (i_{dsCmd} and i_{qsCmd}) as compensation values at nodes 43 and 45 of FIG. 2. The controller 50 thereafter controls torque operation of the induction motor 14 using the final values (i_{dsCmdF} and i_{qsCmdF}) shown in FIG. 3.

Similarly, step S110 entails executing a second control action (CA #2) with respect to the induction motor 14 using the decreasing voltage ellipse direction unit vector (V₁, V₂) to calculate the direction of the compensation values applied at nodes 43 and 45 of FIG. 2, i.e., Δi_{ds} and Δi_{qs}. The controller 50 thereafter controls the torque operation of the induction motor 14 using the final values, i.e., i_{dsCmdF} and i_{qsCmdF}.

The method 100 of FIG. 4, when implemented using the example control logic 40 of FIG. 2, is thus intended to allow the controller 50 to determine, in real-time, when to enter a flux-weakening region of the induction motor 14. As will be appreciated, the performance curves represented by traces 72 and 76 of FIG. 3 change during operation, and thus real-time adaptation of flux-weakening becomes necessary. In addition to minimizing torque error, the method 100 seeks to maintain stability of the voltage control loop of the induction motor 14. Thus, the proposed flux-weakening regulator control loop 55, enhanced by operation of the CCG logic block 42 of FIG. 2, enables use of the vectors (T₁, T₂) and (V₁, V₂) to determine precisely when to enter the MTPV region of operation for the induction motor 14, with vector (T₁, T₂) used below MTPV and vector (V₁, V₂) used above MTPV to adjust d-axis and q-axis current commands.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; modifications, changes, and variations apparent from the foregoing descriptions are within the scope of the disclosure as defined by the appended claims. Moreover, the present concepts expressly include any and all combinations and subcombinations of the preceding elements and features.

1. A method for controlling an induction motor having a stator and a rotor, the method comprising:
generating d-axis and q-axis current command reference signals of the stator using a controller;
generating a current compensation value via the controller using a commanded modulation index and an actual/feedback modulation index of the induction motor;
deriving an angle (θ) between a constant torque direction unit vector and a decreasing voltage ellipse unit vector of the induction motor;
deriving separate d-axis and q-axis components of the current compensation value using the angle (θ);
determining a direction of the current compensation value as a direction of the constant torque unit vector when cos θ is greater than or equal to a calibrated threshold, and as a direction of the decreasing voltage ellipse unit vector when cos θ is less than the calibrated threshold;
adding the separate d-axis and q-axis components to the d-axis and q-axis current command references, in the determined direction, to derive final d-axis and q-axis current commands; and
controlling output torque of the rotor using the final d-axis and q-axis current commands.

2. The method of claim 1, further comprising calculating cos θ online via the controller, in real-time.

3. The method of claim 1, further comprising calculating the direction of the constant torque direction unit vector as a function of a predetermined electromagnetic torque of the induction motor in a synchronous reference frame and the d-axis and q-axis current commands of the stator in the synchronous reference frame.

4. The method of claim 1, further comprising calculating the direction of the decreasing voltage ellipse unit vector as a function of a frequency of a supply voltage to the induction motor, a transient inductance of the stator, an inductance of the stator, and d-axis and q-axis voltage commands of the stator in the synchronous reference frame.

5. The method of claim 1, further comprising receiving a set of input signals, via the controller, indicative of a commanded torque of the induction motor, a DC link voltage, and a rotational speed of the rotor, and then generating the d-axis and q-axis current command reference signals using the set of input signals.

6. The method of claim 1, wherein the rotor is coupled to a driven load of a vehicle, and wherein controlling a torque operation of the rotor includes delivering torque from the induction motor to the driven load via the rotor.

7. The method of claim 6, wherein the driven load includes a set of road wheels of a motor vehicle.

8. An electric system comprising:
an induction motor having a stator and a rotor; and
a controller in communication with the induction motor and configured to:
generate d-axis and q-axis current command reference signals of the stator;
generate a current compensation value using a commanded modulation index and an actual/feedback modulation index of the induction motor;
derive an angle (θ) between a constant torque direction unit vector and a decreasing voltage ellipse unit vector of the induction motor;
derive separate d-axis and q-axis components of the current compensation value using the angle (θ);
determine a direction of the current command compensation as a direction of the constant torque unit vector when cos θ is greater than or equal to a calibrated threshold, and as a direction of the decreasing voltage ellipse unit vector (V₁, V₂) when cos θ is less than the calibrated threshold;
add the separate d-axis and q-axis components to the d-axis and q-axis current command references, in the determined direction, to derive final d-axis and q-axis current commands; and
control output torque of the rotor using the final d-axis and q-axis current commands.

9. The electric system of claim 8, wherein the controller is configured to calculate cos θ online in real-time.

10. The electric system of claim 8, wherein the controller is configured to calculate the direction of the constant torque direction unit vector as a function of a predetermined electromagnetic torque of the induction motor in a synchronous reference frame of the induction motor and the d-axis and q-axis current commands of the stator in the synchronous reference frame of the induction motor.

11. The electric system of claim 8, wherein the controller is configured to calculate the direction of the decreasing voltage ellipse unit vector (V₁, V₂) as a function of a frequency of a supply voltage to the induction motor, a transient inductance of the stator, an inductance of the stator, and d-axis and q-axis voltage commands of the stator in the synchronous reference frame of the induction motor.

12. The electric system of claim 8, further comprising a sensor configured to measure a rotational speed of the rotor, wherein the controller is configured to receive a set of input signals indicative of a commanded torque of the induction motor, a DC link voltage, and the rotational speed of the rotor, and to generate the d-axis and q-axis current command reference signals using the set of input signals.

13. The electric system of claim 8, wherein the rotor is coupled to a driven load of a vehicle, and wherein the controller is configured to command delivery of output torque from the rotor to the driven load via the rotor.

14. The electric system of claim 13, wherein the driven load includes a set of road wheels.

15. A motor vehicle comprising:
a transmission having an input member and an output member;
a set of road wheels connected to the output member of the transmission;
an induction motor having a stator and a rotor, wherein the rotor is connected to the input member of the transmission; and
a controller in communication with the sensor and the induction motor, wherein the controller is configured to:
generate d-axis and q-axis current command reference signals of the stator;
generate a current compensation value using a commanded modulation index and an actual/feedback modulation index of the induction motor;
derive an angle (θ) between a constant torque direction unit vector and a decreasing voltage ellipse unit vector of the induction motor;
derive separate d-axis and q-axis components of the current compensation value using the angle (θ);
calculate cos θ online in real-time;
determine a direction of the current command compensation as a direction of the constant torque unit vector when cos θ is greater than or equal to a calibrated threshold, and as a direction of the decreasing voltage ellipse unit vector when cos θ is less than the calibrated threshold;
add the separate d-axis and q-axis components to the d-axis and q-axis current command references, in the determined direction, to derive final d-axis and q-axis current commands; and
control a level of output torque of the rotor transmitted to the input member of the transmission using the final d-axis and q-axis current commands.

16. The motor vehicle of claim 15, wherein the controller is configured to calculate the direction of the constant torque direction unit vector as a function of a predetermined electromagnetic torque of the induction motor in a synchronous reference frame of the induction motor and the d-axis and q-axis current commands of the stator in the synchronous reference frame of the induction motor.

17. The motor vehicle of claim 16, wherein the controller is configured to calculate the direction of the decreasing voltage ellipse unit vector as a function of a frequency of a supply voltage to the induction motor, a transient inductance of the stator, an inductance of the stator, and d-axis and q-axis voltage commands of the stator in the synchronous reference frame of the induction motor.

18. The motor vehicle of claim 17, further comprising a speed sensor configured to measure a rotational speed of the rotor, wherein the controller is configured to receive a set of input signals indicative of a commanded torque of the induction motor, a DC link voltage, and the rotational speed of the rotor, and to generate the d-axis and q-axis current command reference signals using the set of input signals.
